(19) United States
(12) Patent Application Publication
(10) Pub. No.: US 2015/0354204 A1
(43) Pub. Date: Dec. 10, 2015

(54) A Fastening Member for Fastening Elongated Terrace Elements and an Arrangement Comprising the Same

(71) Applicant: UPM-KYMMENE CORPORATION, Helsinki (FI)

(72) Inventors: Ari Kinnunen, Lahti (FI); Harri Latikka, Virenoja (FI); Katri Parovuori, Nastola (FI)

(21) Appl. No.: 14/761,391

(22) PCT Filed: Feb. 22, 2013
(86) PCT No.: PCT/FI2013/050197

§ 371 Date: Jul. 16, 2015

(51) Int. Cl. E04B 1/41; F16B 2/06; E04B 1/00; F16M 13/02

(52) U.S. Cl. CPC E04B 1/40; F16M 13/02; F16B 2/065; E04B 1/003

(57) ABSTRACT

A fastening member, comprising a first extension having a thickness in a first direction, extending in a second direction, and having a length in a third direction; a second extension connected to the first extension and extending in a direction that is reverse to the second direction; and a hole penetrating the fastening member. The fastening member comprises at least one projection, wherein the projection protrudes from the first extension to the first direction or to a direction that is reverse to the first direction. A method for fastening two elements to a support, the method comprising inserting the first extension of the fastening member to a groove of an element; arranging a second element such that another extension of the fastening member becomes arranged into a groove of the second element; and fixing the fastening member to a support using a fixing means such as a screw.

### FIELD OF THE INVENTION

This invention relates to a fastening member for elements such boards. In addition, the invention relates to an arrangement wherein the elements are fastened using such fastening members.

### BACKGROUND OF THE INVENTION

Decking boards are typically used as terrace boards. Fastening of the decking boards and the railstep boards is usually implemented by screwing screws through the elements to the substructure. The screws, while penetrating through the elements both deteriorate the visual appearance and also provide a leakage for fluids, e.g. water, and moisture to penetrate into the element. This may reduce the service life of the decking board.

### SUMMARY OF THE INVENTION

The present invention discloses a new fastening member. The present invention further discloses an arrangement wherein elements, such as boards, are fastened using a fastening member. Additionally, the present invention discloses a use of the fastening member. The element, such as the board comprises a groove. The fastening member comprises a respective extension, adapted to the groove. However, the manufacturing tolerance of the groove is reasonably large. Therefore, in order to fit the fastening member to many grooves have different heights, the a part of the fastening member is deformable.

An embodiment of the fastening member comprises
a first extension (i) having a thickness in a first direction, (ii) extending in a second direction, wherein the second direction is perpendicular to the first direction, and (iii) having a length in a third direction, wherein the third direction is perpendicular to the first direction and the third direction is perpendicular to the second direction,
a second extension connected to the first extension and extending in a direction that is reverse to the second direction,
at least one hole penetrating the fastening member such that the central axis of the hole is parallel to the first direction or forms a first angle with the first direction, wherein the first angle is less than 45 degrees, and
at least one projection, wherein
the projection protrudes from the first extension to the first direction or to a direction that is reverse to the first direction.

The fastening member may be used in combination with elements such as boards, planks, panels, plates, and/or sheets. Such a combination comprises
a fastening member,
at least a first element comprising a first tongue and a second tongue, whereby a groove having a height of the groove is arranged in between the first tongue and the second tongue, wherein
the total thickness of the first extension and the projection is greater than the height of the groove.

In particular, the fastening member may be used to fasten an element to a support. In such a use, an arrangement is formed. Such an arrangement comprises
a fastening member,
a first element comprising a first groove,
a second element comprising a second groove,
the first extension of the fastening member is arranged to the first groove, and
another extension of the fastening member is arranged to the second groove.

In an arrangement, a first element is arranged parallel to a second element, and these elements are fastened using a fastening member.

In another arrangement, a first element is arranged at another angle, such as 30±2 degrees, 45±2 degrees, 60±2 degrees, or more than 89 degrees in respect to a second element, and these elements are fastened using a fastening member.

Moreover, an arrangement further comprises
a support and
a fixing means, such as a screw, wherein
the fixing means penetrates through the hole of the fastening means to the support.

When fastening elements to a support, a method for fastening two elements to a support is performed. An embodiment of the method comprises
optionally arranging available a first element comprising a first groove and arranging the first element next to a support,
arranging available a fastening member,
arranging available a second element comprising a second groove,
   and the method comprises, in the following order
(a,i) inserting the first extension of the fastening member to the first groove of the first element,
(a, ii) arranging the second element such that another extension of the fastening member becomes arranged into the second groove, and
(a, iii) fixing the fastening member to the support using a fixing means such as a screw; OR in the following order
(b,i) inserting the first extension of the fastening member to the second groove of the second element,
(b, ii) arranging the second element such that another extension of the fastening member becomes arranged into the first groove, and
(b, iii) fixing the fastening member to the support using a fixing means such as a screw.

It has also been found that, regardless of some details of the fastening member, a gap in between a support and a fastening member helps air circulation, and thereby increases the service life of the arrangement. Such an arrangement can be formed using a combination of an element and a fastening member. Such a combination comprises

a fastening member, comprising
a first extension having a height in a first direction and extending in a second direction, wherein the second direction is perpendicular to the first direction,
a second extension connected to the first extension and extending in a direction that is reverse to the second direction,
at least one hole penetrating the fastening member in a direction such that the central axis of the hole is parallel to the first direction or forms a first angle with the first direction, wherein the first angle is less than 45 degrees, and
a foot part connected to the at least one of the first extension and the second extension, and extending from the at least one extension in a direction reverse to the first direction, and
   an element comprising a
a first tongue, and
the first tongue has a thickness, wherein
   the height of the foot part of the fastening member is less than the thickness of the first tongue.

### DESCRIPTION OF THE DRAWINGS

FIG. 1a shows, in an end view, an arrangement comprising a support, two elements, and a fastening member,

FIG. 1b shows, in an end view, the fastening member of FIG. 1a,

FIG. 1c shows, in a side view, the fastening member of FIG. 1a,

FIG. 1d shows, in a perspective view, the fastening member of FIG. 1a,

FIG. 2a shows, in an end view, an arrangement comprising a support, two elements, a fixing means, and a fastening member,

FIG. 2b shows, in an end view, the fastening member of FIG. 2a,

FIG. 2c shows, in a side view, the fastening member of FIG. 2a,

FIG. 2d shows, in an end view, an arrangement comprising a support, two elements, a fixing means, and a fastening member having a projection that protrudes in the positive first direction Sx,

FIG. 2e shows, in an end view, an arrangement comprising a support, two elements, a fixing means, and a fastening member of FIG. 2b,

FIG. 2f shows, in a side view and in detail, the part IIf of FIG. 2c,

FIG. 3a shows, in an end view, a fastening member with two foot parts,

FIG. 3b shows, in an end view, a fastening member having rounded extensions,

FIG. 4a shows, in a perspective view, a fastening member,

FIG. 4b shows a cross sectional view of the fastening member of FIG. 4a, wherein the plane of cross section has the surface normal Sz, and the plane of cross section is located in the centre of fastening member,

FIG. 4c shows a cross sectional view of the fastening member of FIG. 4a, wherein the plane of cross section has the surface normal Sy, and the plane of cross section is located in the centre of fastening member; thus, the plane of the cross section is the central plane CP (FIG. 1b),

FIG. 4d shows, as seen from bottom, i.e. from the smaller values of Sx towards the larger values of Sx, the fastening member of FIG. 4a,

FIG. 4e shows, as seen from top, i.e. from the larger values of Sx towards the smaller values of Sx, the fastening member of FIG. 4a,

FIG. 5a shows, in an end view, a combination of a fastening member and an element,

FIG. 5b shows, in a side view, an element to be fastened with the fastening member,

FIG. 5c shows, in a side view, another element to be fastened with the fastening member,

FIG. 6a shows, in an end view, a fastening member having projections in both the first direction and a direction that is reverse to the first direction,

FIG. 6b shows, in an end view, an arrangement of a support, two elements, a fixing means, and a fastening member,

FIG. 6c shows, as seen from top, the arrangement of FIG. 6b, wherein the elements are parallel,

FIG. 7a shows, as seen from top, an arrangement of a support, two elements, and a fastening member, wherein the elements are perpendicular to each other, and

FIG. 7b shows, as seen from top, an arrangement of a support, three elements, and a fastening member,

FIG. 7c shows, as seen from top, an arrangement of a support, three elements, and a fastening member,

FIG. 8 shows, in an end view, an arrangement of a support, two elements, a fixing means, and a fastening,

FIG. 9a shows, in a top view, a preferred embodiment of a fastening member,

FIG. 9b shows, in a side view, the fastening member of FIG. 9a,

FIG. 9c shows, in an end view, the fastening member of FIG. 9a,

FIG. 9d shows, in a bottom view, the fastening member of FIG. 9a,

FIG. 9e shows, in another side view, the fastening member of FIG. 9a,

FIG. 9f shows, in another end view, the fastening member of FIG. 9a,

FIG. 9g shows, in a perspective view, the fastening member of FIG. 9a, and

FIG. 9h shows, in a perspective view, the fastening member of FIG. 9a.

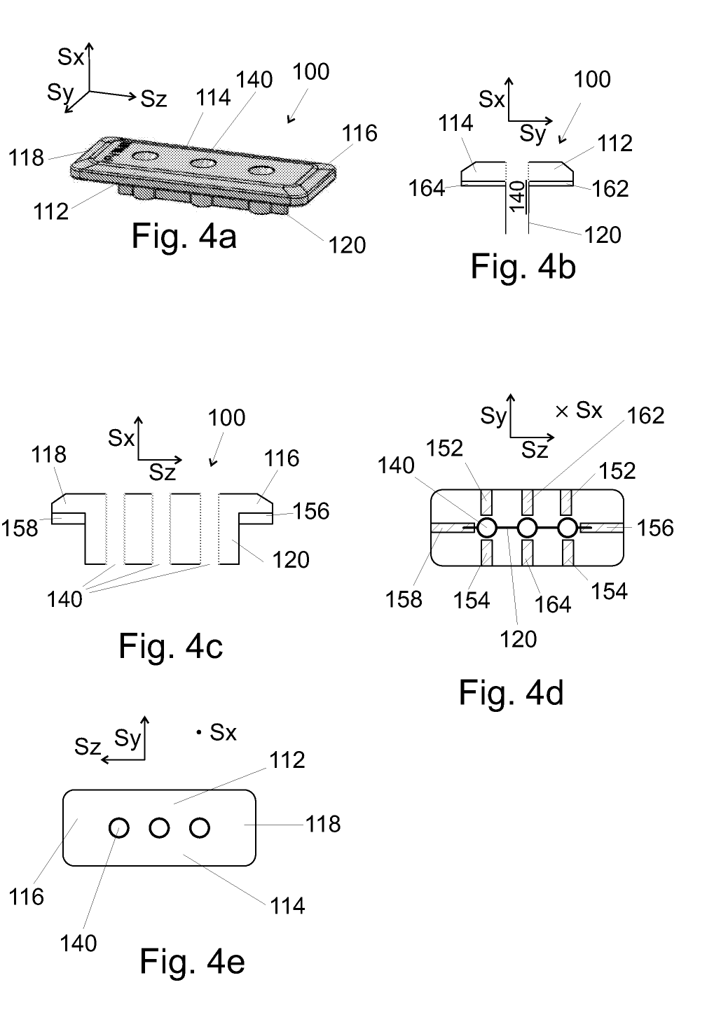

In FIGS. 4d, 4e, 7a-7c, and 9a-9e a dot (•) in combination with a direction label (Sx, Sy, Sz) is used to represent a direction that is perpendicular to the plane of the figure and extends towards the reader, and a cross mark (x) in combination with a direction label (Sx, Sy, Sz) is used to represent a direction that is perpendicular to the plane of the figure and extends away from the reader.

### DETAILED DESCRIPTION OF THE INVENTION

The invention relates to a fastening member. The invention relates in particular to a fastening member for fastening elongated terrace elements. An elongated terrace element is typically used for terrace flooring, and has a length that is considerably (at least ten times) larger than the width. Such elements are generally fastened to a support. The support is generally on another level than the element itself, i.e. the support may e.g. under the element.

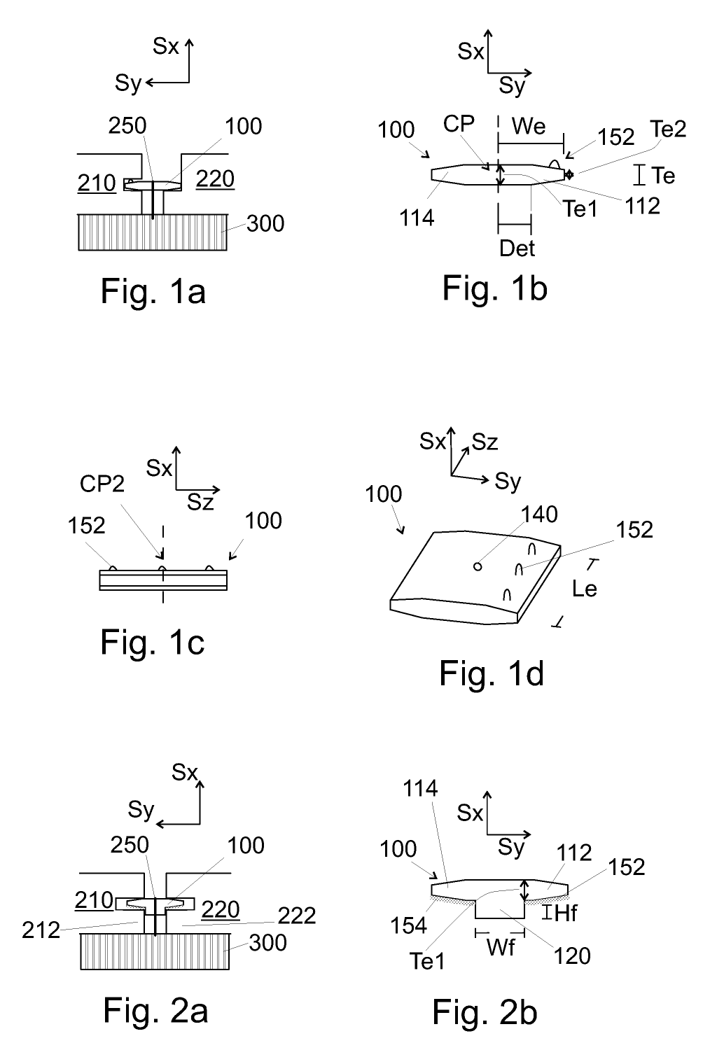

FIG. 1a shows in a side view an arrangement comprising a fastening member 100, a fixing means 250, a first element 210, a second element 220, and a support 300. Fastening members are often used to fasten elements to a support 300. The support 300 may be e.g. a plank, a beam, a balk, timber, or a frame. The element 210, 220 may be e.g. panel or a board such as a decking board or a railstep board. Such elements often comprise at least one groove, typically at least two grooves; one on a first edge and another on an opposite edge. A fastening member 100 can be inserted to the groove of an element 210, 220 and fixed to a support 300 by a fixing means 250 such a nail or a screw. In this way, the fastening member 100 fastens the element 210, 220 to the support 300 from the groove. Referring to FIG. 1a, the fastening member 100 may be inserted into a first groove of a first element 210 and into a second groove of a second element 200. In this way, the fastening member can be used to fasten two elements 210, 220 to the support 300. However, as depicted in FIG. 1a, it is possible that the groove is limited by only one tongue, as in the case of the element 220.

In known elements 210, 220 there are various manufacturing tolerances. For example, the height of the groove may depend on the location, wherein the height is measured. Moreover, the groove may be arranged to a height that varies. More specifically, the groove may be limited by one tongue, as the in the element 220 of FIG. 1a, or more typically, the groove may be arranged between two tongues, as in the case of the element 210 of FIG. 1a. The thickness of the tongue may vary from location to location, whereby the location of the groove may vary.

In addition to manufacturing tolerances, the variations in groove and tongue height may be due to swelling by moisture absorption. In addition or alternatively, the variations in groove and tongue height may be due to warpage of the whole element.

When fastening the elements, it is preferable that the fastening member 100 can be attached to an element (e.g. element 210) such that the fastening member 100 does not drop off from the groove of the element 210. A fastening member could drop off from the groove of the element 210 once the person who is constructing the object, e.g. a flooring, releases the fastening member 100. Alternatively, a fastening member could drop off from the groove due to vibrations of the element and/or the support on which the element is located. If the thickness of the fastening member 100 would be smaller than the height of the groove, the fastening member 100 could be inserted into a groove, but would, however fall off from the groove once it is released or due to vibrations. Such a fastening member could be pre-attached to a support to prevent the detachment. However, pre-attaching would increase the number of process steps and thereby increase construction time and cost. A regular fastening member, however, cannot be made such that the thickness is exactly adapted to the height of the groove, since the height of the groove varies.

The fastening member 100, as will be disclosed, has the at least the following technical features
similar fastening members can be inserted to grooves having slightly different heights,
a fastening member that is at least partly inserted to a groove stays fixed to the groove even after releasing the fastening member, and
at least a part of the fastening member is insertable into a groove with a reasonable small force or momentum.

The term “stays fixed” refers to the gravitational and vibrational forces typically occurring on a construction site. Thus, the fastening member that is at least partly inserted to a groove is not removable by very small forces, such as forces of less than 2 N or less than 1 N. However, as will be discussed, it may be beneficial that the fastening member that is at least partly inserted to a groove is removable by larger forces, such as at least 5 N, at least 2 N, or at least 1 N. Moreover, as will be discussed, it may be beneficial that the fastening member that is at least partly inserted to a groove is removable by fingers, i.e. forces that are at most 50 N or at most 30 N.

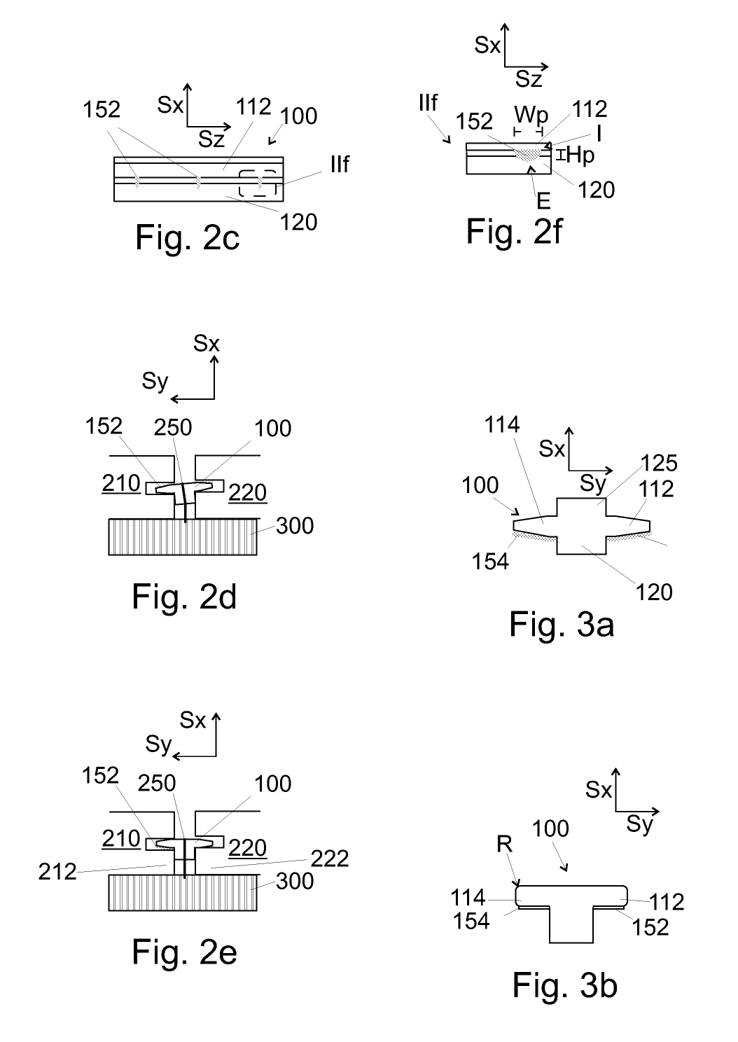

In connection with the feature “is insertable into a groove with a reasonable small force”, the reasonable small force refers to a force that can be generated by fingers, e.g. at most 50 N, preferably at most 30 N. The reasonable small momentum refers to the momentum of the head of a hammer, such as a rubber hammer or a metal hammer, which may be used to insert a part of the fastening member into a groove. The reasonably small momentum may be e.g. at most 2 kgm/s, preferably at most 1 kgm/s. An object, e.g. a hammer or similar, having this momentum, and allowed to hit the fastening member, is capable of inserting a part of the fastening member 100 into the groove. However the momentum should not be too high, since this could break the fastening member and/or the element. Preferably the whole first extension 112, excluding the foot part 120 (if present), can be inserted into a groove with the prescribed force. More specifically, preferably the whole width We−Wf/2 (cf. FIGS. 1b and 2b) of the first extension 112 can be inserted into a groove with such a force or a momentum.

A fastening member 100 having the described functional features with a corresponding element, is shown in detail in FIGS. 1b to 1d. With reference to FIGS. 1a to 1d, in the following, the “first direction”, denoted by Sx, may refer e.g. to the upward vertical direction. For example, when a substantially horizontal floor is assembled, the first direction refers to upward vertical. In other configurations, the first direction may be otherwise directed. A second direction, denoted by Sy, is perpendicular to the first direction. A third direction, denoted by Sz, is perpendicular to both the first and the second directions. In this description, the positive third direction is oriented as in common right hand coordinate systems, as depicted in the figures. However, this is not necessary.

Moreover the terms “thickness” and “height” mean typically a measure in the first direction. An exception is a combination of parts, such as the elements and the fastening member, when the parts are not mutually aligned in any prescribed way.

The fastening member 100 is suitable for fastening an element to a support, wherein the support is, in the first direction Sx, in a different level than the element. The term “level” here meaning the position in the first direction, such as height.

Referring to FIGS. 1b to 1d, a fastening member 100 comprises
a first extension 112 having a thickness Te in a first direction Sx and extending in a second direction Sy, wherein the second direction Sy is perpendicular to the first direction Sx,
a second extension 114 connected to the first extension 112 and extending in a direction −Sy that is reverse to the second direction Sy,
at least one hole 140 (FIG. 1d) penetrating the fastening member 100 such that the central axis of the hole 140 is parallel to the first direction

Sx or forms a first angle with the first direction Sx, wherein the first angle is less than 45 degrees, and
at least one projection 152, wherein
the projection 152 is arranged to the first extension 112, and
the projection 152 protrudes to the first direction Sx or to a direction −Sx that is reverse to the first direction Sx.

As is obvious, has the first extension 112 has a length Le in a third direction Sz, wherein the third direction Sz is perpendicular to the first direction Sx and the third direction Sz is perpendicular to the second direction Sy, and

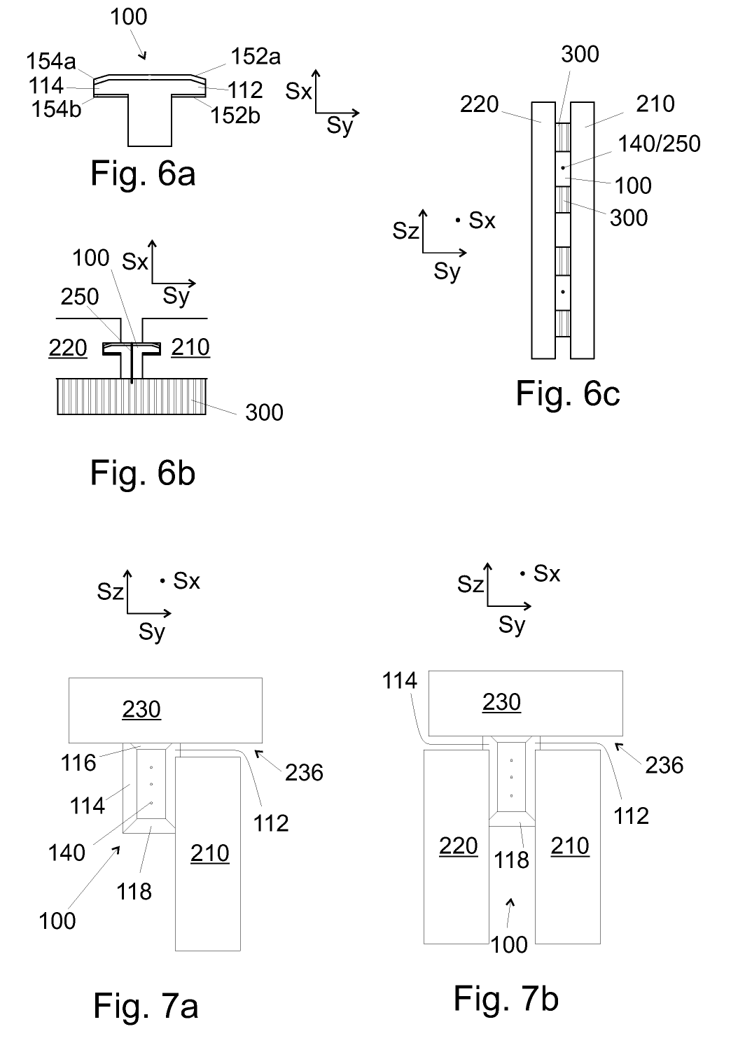

In an embodiment, the projection 152 protrudes only in the first direction Sx. In an embodiment, the projection 152 protrudes only in a direction −Sx that is reverse to the first direction Sx. In an embodiment, a first projection 152a protrudes in the first direction Sx and a second projection 152b protrudes in a direction −Sx that is reverse to the first direction Sx (FIG. 6a). In an embodiment, all the projections protrude in the same direction. In an embodiment, all the projections protrude in the same direction as a foot part 120, e.g. the direction −Sx that is reverse to the first direction Sx.

As will be discussed, similar projections may be arranged to the second extension 114 and other extensions (if present).

An extension 112, 114 may comprise, on one or both sides (i.e. on top projections that protrude in the +Sx direction, and on bottom projections that protrude in the −Sx direction), a number of projections. The number of projections in the first extension 112 may be e.g. one, more than one, two, more than two, three, more than three, four, more than four, five, more than five, six, or more than six. The other extensions (second 114, third 116, or fourth 118) may comprise a number of projections. The number of projections in another extension 114, 116, 118 may be e.g. zero, one, more than one, two, more than two, three, more than three, four, more than four, five, more than five, six, or more than six.

Preferably, the projection 152 is deformable. This can be achieved by proper sizing of the projection 152. This can also or alternatively be achieved by proper selection of the material of the projection. However, for manufacturing reasons, preferably the whole fastening member 100 is made of the same material. Deformable in this context means that the projection 152 and/or the element deforms, when the first extension 112 is inserted into a respective groove with a reasonably small force or momentum, as discussed above.

Preferably, the hole 140 penetrates through the fastening member 100 in such a way that the central axis of the hole 140 is parallel or substantially parallel to the first direction Sx. The term “substantially parallel” may here be interpreted such that the smaller of the two angles between the first direction and the central axis of the hole, when considering these directions in a common plane, is at most 15 degrees, preferably at least 5 degrees.

The fastening member should be reasonably sturdy. This can be affected, on one hand by the selection of material, and on the other hand by the size of the fastening member. However, as will be discussed, the thickness Te of the first extension 112 is limited by use; in particular, by a height of a corresponding groove. To increase strength, the length Le (FIG. 1d) of the first extension can be more freely increased. In an embodiment,
the first extension 112 has a length Le in a third direction Sz, wherein the third direction Sz is perpendicular to the first direction Sx and the third direction Sz is perpendicular to the second direction Sy, and
the length Le of the first extension 112 is greater than the thickness Te of the first extension 112.

Preferably the ratio of the length Le to the thickness Te, Le/Te, is at least 2 or more preferably at least 5. In some embodiments, the ratio is as more than 10.

As shown in FIG. 1b, the first extension 112 and the second extension 114 extend in reverse directions (i.e. the positive and negative second direction). Thereby a central plane CP can be defined for the fastening member. The central plane has a surface normal parallel to the second direction Sy, whereby the central plane CP comprises the first direction Sx. The central plane divides the fastening member to two equally large parts. In some embodiments the fastening member is symmetrical such that the central plane CP is a plane of symmetry.

In a corresponding manner, a second central plane CP2 (FIG. 1c) can be defined such that the second central plane CP2 has a surface normal parallel to the third direction Sz. In some embodiments the fastening member is symmetrical such that the second central plane CP2 is a plane of symmetry. In some embodiments the fastening member is symmetrical such that both the central plane CP and the second central plane CP2 are planes of symmetry.

With reference to FIG. 1a, the width We of the first extension 112, the width of the second extension 114, and the depths of the grooves of the elements 210, 220, in combination, will determine the distance that is left in between the two elements 210, 220. However, often the depth of the groove (i.e. width of the corresponding tongue in the second direction Sy) varies a lot, whereby the fastening member cannot be used to control the spacing between two elements. For a controlled separation between two elements, the fastening member 100 may be equipped with a foot part 120.

FIG. 2a shows another embodiment of a fastening member 100 located in between two elements 210, 220. With reference to FIG. 2b, the fastening member 100 further comprises
a foot part 120 connected to the at least one of the first extension 112 and the second extension 114, and extending from the at least one extension (112, 114) in a direction −Sx reverse to the first direction Sx.

As shown in FIGS. 2a and 2b, the width Wf of the foot part 120 determines the separation of the two elements 210, 220. Therefore, when the fastening member 100 comprises a foot part 120, the elements 210, 220 are more easy to align with respect to each other than without the foot part 120.

With reference to FIGS. 2b and 2c, in an embodiment of the fastening member
the projection 152 extends in a direction of extension, wherein
the direction of extension is parallel to the second direction or forms a second angle with the second direction Sy, wherein the second angle is at most 45 degrees.

As the projection 152 extends in the direction of extension, the projection 152 may stiffen the first extension 112. Thereby the extending projection may strengthen the fastening member, the degree of strengthening depending on the dimensions of the projection 152. This relatively small angle has two effects. (1) the strengthening as discussed is more effective and (2) the first extension 112 of the fastening member 100 can be inserted into a groove substantially perpendicularly to an edge of the element 210, 220. Thereby the location of the fastening member in the groove is well controlled by the construction worker.

As shown in the FIGS. 2b and 2c, the direction of extension is preferably parallel or substantially parallel to the second direction Sy. The term “substantially parallel” may here be interpreted such that the smaller of the two angles between the direction of extension and the second direction Sy is at most 15 degrees, preferably at most 5 degrees. In an embodiment, the direction of extension is arranged in the plane comprising the second direction Sy and having the surface normal parallel to the first direction Sx. Such a case is shown in FIGS. 4b to 4c.

Referring to FIG. 2b, an embodiment of the fastening member comprises
a second projection 154, wherein
the second projection 154 is arranged to the second extension 114,
the second projection 154 protrudes to the first direction Sx or to a direction −Sx that is reverse to the first direction Sx.

This has the technical effect that either the first extension 112 or the second extension 114 can be inserted into a groove in the described manner. Thus, a construction worker does not need to determine, which extension is to be inserted into a groove.

As shown in FIGS. 2b and 2c, in an embodiment, the second projection 154 extends in a second direction of extension, wherein (i) the second direction of extension is parallel to the direction −Sy that is reverse to the second direction Sy, or (ii) the second direction of extension forms a third angle with the direction −Sy that is reverse to the second direction Sy, wherein the third angle is at most 45 degrees.

In some embodiments, the second direction of extension is parallel or substantially parallel to the direction −Sy that is reverse to the second direction Sy. The term substantially parallel to be interpreted as above for the (first) direction of extension. In some embodiments, the second direction of extension is arranged in the plane comprising the second direction Sy and having the surface normal parallel to the first direction Sx (FIG. 4b).

Referring still to FIGS. 2a to 2c, in an embodiment
the first projection 152 protrudes in a direction −Sx that is reverse to the first direction Sx, and
the second projection 154 protrudes to the direction −Sx that is reverse to the first direction Sx.

In this embodiment, the foot part 120 may also extend to the direction −Sx reverse to the first direction Sx. When the foot part 120 and the extensions 112, 114 are protruding to the same direction, this decreases the effect of tilting, and further help to accurately align the elements 210, 220 with respect to each other, as will be discussed. The fastening member may comprise further projections protruding to the (positive) first direction Sx.

The corresponding arrangement (FIG. 2a) comprises a first element 210, a support 300, and a fixing means 250, such as a screw, wherein the fixing means 250 penetrates through the hole 140 of the fastening means 100 to the support 300. Typically the arrangement comprises also the second element 220 as depicted in the FIG. 2a.

Furthermore, in the arrangement,
the first element 210 has two sides,
the support 300 is arranged on the first side of the first element 210, and
the projection 152 of the fastening member 100 protrudes towards the support 300.

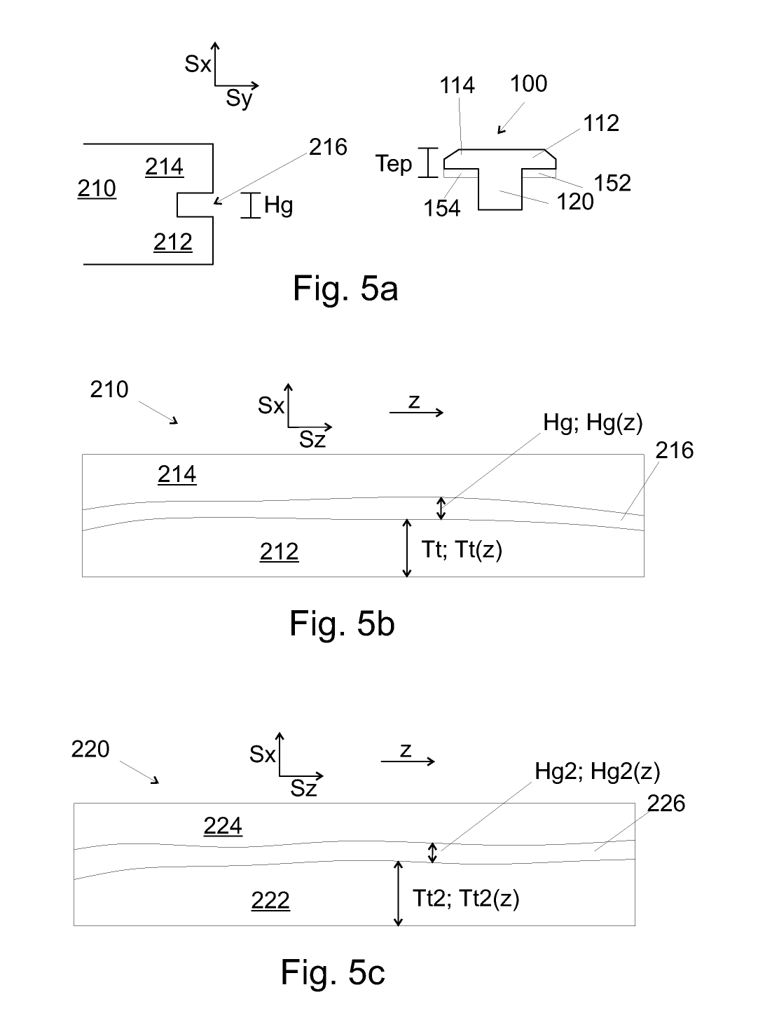

This embodiment takes into account both the variations discussed above; the variation related to the height Hg of the groove 216 (cf. FIGS. 5a and 5b), and the variation related to the thickness Tt of the tongue 212 (cf. FIGS. 5a and 5b).

(1—groove) The variation in the height Hg of the groove is taken into account by the existence of the projection 152. When the first extension 112 is inserted into a groove 216 of the element, at least one of the projection, the extension, and the element deforms in such a manner that the first extension 112 can be inserted into the groove 216. The preferable force or momentum for this insertion was discussed above. Preferably at least the projection 152 deforms. More preferably, at least half of the deformations occur in the projection 152. More preferably, at least 80% of the deformations occur in the projection 152. The material of the projection 152 is preferably the same as the material of the first extension 112. Preferably the whole fastening member 100 is made of the same material. Dimensions of the projection 152 will be discussed later.

(2—tongue, first aspect) The variation in the thickness Tt of the tongue 212 (i.e. the position of the groove 216 in the first direction Sx) is taken into account by directing the projection 152 towards the support 300. Thus, when the fixing means 250 is used to fix the elements 210, 220 to the support 300, it is the projection 152 (or projections 152, 154), that is/are pressed towards the tongue 212 of the element (possibly also a tongue 222 of a second element). As the projection 152 may be deformable, the deformation of the projection(s) determine the force by which the element(s) 210, 220 become pressed against the support 300. Naturally, this force is also affected by the fixing means 250.

(2—tongue, second aspect) Furthermore, because of the projection and in case the thickness of the tongue 212 of the first element 210 is different from the thickness of the tongue 222 of the second element 220, the second direction (Sy) can be substantially parallel to the plane of the support 300, as depicted in FIG. 2e, regardless of the different thicknesses of the tongues. In case the projections would protrude in the (positive) first direction Sx (FIG. 2d), the (non-deformable part) of the extension 112, 114 would be pressed towards the tongues 212, 222. Therefore, by fixing the fastening means 100 to the support 300 with the fixing means 250, the fastening means 100 would be tilted, as depicted in FIG. 2d. When the fastening means comprises the foot part 120, tilting affects the distance by which the elements 210, 220 are separated. Therefore, preferably, the fastening member is not tilted or tilted only a little in such a configuration. As depicted in the FIG. 2e, and as discussed above, when the projections 152, 154 protrude in the same direction as the foot part, the projections 152, 154 press the elements 210, 220 to the support. This reduces, at least to some extent, tilting and in this way helps to form an even separation between the different elements 210, 220.

As depicted in FIGS. 1b, 1d, and 2b, in some embodiments the thickness of the first extension 112 decreases to the second direction Sy. That is, the thickness of the first extension depends on the point of observation, and the thickness of the first extension decreases as the point of observation moves towards the second direction. The thickness of the extension refers to the measure of the extension in the first direction Sx at the point of observation. Thus, in an embodiment,
the first extension 112 has a first thickness Te(y1) at a first location y1,
the first extension 112 has a second thickness Te(y2) at a second location y2, wherein
the second thickness Te(y2) is less than the first thickness Te(z1), and
the second location y2 is closer to a boundary of the first extension 112 than the first location y1.

Preferably, the thinning of the first extension 112, as discussed above, occurs at a relatively long distance. This on one hand ensures that the extension 112 can easily be inserted to the groove, and on the other hand affects the mechanical properties of the fastening member. In an embodiment
the shape of the fastening member 100 defines a central plane CP (FIG. 1b) having a surface normal parallel to the second direction Sy and dividing the fastening member 100 to two equally large parts,
the first extension 112 has a width We from the central plane CP of the fastening 100 member to the boundary of the first extension 112 in the second direction Sy, and
the thickness Te of the first extension 112 depends on the point of observation in such a way that
the thickness Te of the first extension starts to decrease a distance Det apart from the central plane CP, wherein
the distance Det is at most 85%, preferably at most 70% of the width We of the first extension 112.

Moreover, the amount of thinning is preferably significant. Significant meaning that the thickness decreases quite a lot when moving from the central part to the boundary. In an embodiment
the shape of the fastening member 100 defines a central plane CP having a surface normal parallel to the second direction Sy and dividing the fastening member 100 to two equally large parts,
the first extension 112 has first thickness Te1 at the central plane CP (FIG. 1b), or if a foot part 120 is present (FIG. 2b), at the point where the first extension 112 intersects with a foot part 120,
the first extension 112 has second thickness Te2 (FIG. 1b) at the boundary of first extension 112, wherein the boundary is located towards the second direction Sy from the central plane CP,
the ratio of the second thickness Te2 to the first thickness Te1, Te2/Te1, is at most 90%, preferably at most 75%.

Referring to FIG. 3b, thinning can also be achieved by rounding the boundary of the extension 112. In an embodiment, the first extension 112 comprises at least one rounded boundary. In FIG. 3, the boundaries of the extensions 112 and 114 are rounded. This also helps to insert the extension 112 to a groove. Moreover, in case tilting of the fastening member would occur, rounding helps to level out the compressive stresses at the edges. A sharp edge of a tilted fastening member would concentrate large stress onto a tongue of an element. Moreover, rounding is one way of performing the thinning, which has the benefits discussed above. The radius of curvature R for the rounding may be e.g. at least Te/4 or Te/3. The radius of curvature R for the rounding may be e.g. at most 3×Te/4 or 2×Te/3. Preferably radius of curvature R for the rounding is Te/2 or about Te/2 meaning from 0.40×Te to 0.60×Te or from 0.45×Te to 0.55×Te.

A preferred embodiment of the fastening member 100 can be used with an element having a groove height between about 3 mm and 6 mm.

In an embodiment for a groove having the height of approximately 6 mm,
the second thickness Te2 is less than 3.5 mm and
the first thickness Te1 is from 4.0 mm to 5.8 mm.

In an embodiment for a groove having the height of approximately 5 mm,
the second thickness Te2 is less than 3.0 mm and
the first thickness Te1 is from 3.5 mm to 4.8 mm.

In an embodiment for a groove having the height of approximately 4 mm,
the second thickness Te2 is less than 2.5 mm and
the first thickness Te1 is from 3.0 mm to 3.8 mm.

In an embodiment for a groove having the height of approximately 3 mm,
the second thickness Te2 is less than 1.5 mm and
the first thickness Te1 is from 2.0 mm to 2.8 mm.

Moreover, in some embodiments the thickness of the second extension 114 decreases to a direction −Sy that is reverse to the second direction Sy. In such an embodiment, the thickness of the second extension depends on the point of observation, and the thickness of the second extension decreases as the point of observation moves towards a direction that is reverse to the second direction. The thickness of the second extension refers to the measure of the second extension in the first direction Sx at the point of observation. Thus, in an embodiment,
the second extension 114 has a first thickness Te2(y1) at a first location y1,
the second extension 114 has a second thickness Te2(y2) at a second location y2, wherein
the second thickness Te2(y2) is less than the first thickness Te2(y1), and
the second location y2 is closer to a boundary of the second extension 114 than the first location y1.

This thinning has the obvious technical effect that the extension 112 is more easily pushed into a groove. Moreover, in particular, when the tongues have different thicknesses, i.e. two opposing grooves are not located on the same height, thinning of the extensions further helps to insert both the first 112 and the second 114 extensions into the corresponding grooves (cf. FIG. 2e). However, regarding the technical feature related to the tongue having a non-uniform thickness, this has also another effect.

(2—tongue, third aspect) The thinning of the extension 112 has the further technical effect that the described thinning effectively affects the deformations of the projection 152. In effect, the compressibility becomes non-linear. Referring to FIGS. 2a and 2e, it may be that only part of the projection (or projections in case there are several projections, such as in FIG. 2c, in FIG. 1d) is in contact with the tongue 212. By increasing the force of fixing, e.g. by tightening the screw 250, the fastening means 100 is pressed towards the support 300, whereby a larger portion of the projection(s) becomes in contact with the tongue(s) 212, 222. Thereby, the feature that thickness of the first extension 112 decreases to the second direction Sy also in its part decreases the effect of tilting the fastening means. This occurs at least when the extension is thinned at least from the side of the foot part.

To illustrate the size of the projection, FIG. 2f shows an enlargement (not to scale) of the part IIf of FIG. 2c. In the fastening member 100 of FIG. 2c or 2f,
the projection 152 has width Wp in a direction that is perpendicular to the first direction Sx, and
the width Wp is at most 2 mm, preferably at most 1 mm.

In a preferred embodiment,
the projection 152 extends in a direction of extension,
the projection 152 has width Wp in a direction that is (i) perpendicular to the direction of extension and (ii) perpendicular to the first direction, and
the width Wp is at most 2 mm, preferably at most 1 mm.

The width of the projection may also decrease, as depicted in FIGS. 1b and 2f, in the direction of protrusion, i.e. the positive or negative first direction. In an embodiment
the projection 152 has width Wp in a direction that is perpendicular to the first direction,
the projection 152 has a first width at an intersection I (FIG. 2f) between the first extension 112 and the projection 152,
the projection 152 has a second width at the other end E (FIG. 2f) of the projection 152, wherein the other end of the projection is located in the direction of protrusion of the projection, i.e. in the first direction Sx or a direction −Sx that is reverse to the first direction Sx, from the intersection I, and
the second width is smaller than the first width.
   Such a projection may have the shape of a bump, such as a V-shaped bump.

However, in another embodiment
the projection 152 extends in a direction of extension,
the projection 152 has width in a direction that is perpendicular to the direction of extension and perpendicular to the first direction Sx, and
the projection 152 has a first width at an intersection I (FIG. 2f) between the first extension 112 and the projection 152,
the projection 152 has a second width at the other end E (FIG. 2f) of the projection 152, wherein the other end of the projection is located in the direction of protrusion of the projection, i.e. in the first direction Sx or a direction −Sx that is reverse to the first direction Sx, from the intersection I, and
the second width is smaller than the first width.

Moreover, preferably the projection 152 protrudes in the direction −Sx that is reverse to the first direction Sx and the width of the projection decreases in the same direction −Sx. This is particularly true, when the fastening member comprises a foot part 120 that extends to the same direction −Sx. In this embodiment the first end (i.e. the intersection I) of the projection is located in the first direction Sx from the other end (i.e. the end E) of the projection. Such shaping of the projection 152 further enables the deformation of the projection 152 when fixing the fastening member 100 to the support 300.

Still further, the number of the projections should be reasonably small in order to allow for the deformation. For example, in an embodiment, the total cross sectional area Aptot of the projections 152 protruding from the first extension as observed from the first direction Sx, is only a relatively small proportion of the cross sectional area Ae1 of the first extension 112 as observed from the first direction Sx. This relatively small proportion, Aptot/Ae1, may be e.g. at most 25%, at most 10%, or at most 5%.

The thickness of the extension 112 is not necessarily constant. The thickness may e.g. decrease towards to boundary as discussed. Furthermore, to minimize material use, the extension 112 may be relatively thin, but comprise strengthening ribs, such as the ribs 162, 164 of FIGS. 4b and 4d. In either case, the extension 112 has an average thickness. The average thickness refers to the thickness in the first direction Sx, as averaged over the area of the extension.

In an embodiment,
the first extension 112 has an average thickness in the first direction Sx and
the projection 152 has height Hp in the first direction, the height Hp being between located an end (E, FIG. 2f) of the projection 152 and the intersection (I, FIG. 2f) of the projection 152 and a surface of the extension 112, wherein
the height of the projection Hp is at least 5% of the average thickness of the first extension.
   The height of the projection 152 may be e.g. at least 10% or at least 25% of the average thickness of the first extension 112, or at least 50% of the average thickness of the first extension 112.

In a preferred embodiment, the average thickness of the first extension is from 2 mm to 5.5 mm. Specific examples of average thicknesses include 5.2 mm, 4.4 mm and 3.6 mm. This ensures a sufficient strength of the extension 112, as the extension 112 is used to fix an element 210 to the support 300. The strength depend also on the material of which the fastening member is made. The height of the projection may be, for example and in absolute measure from 0.2 mm to 1 mm, preferably from 0.25 mm to 0.7 mm.

The fastening member may comprise polymer. The fastening member may comprise thermoplastic polymer. Preferably the fastening member 100 comprises polyolefin such as polyethylene, polypropylene, or copolymer thereof. The fastening member may be made of a composite comprising polyolefin and natural fibres. Preferably the whole fastening member is made of the same material.

Preferably at least the extensions 112 (optionally 114, 116, 118) and the foot part 120 comprise material that is relatively strong and stiff, in order to fix the elements to a support. Preferably the elastic modulus of the material is at least 700 N/mm² or at least 900 N/mm². Preferably the tensile strength is at least 12 N/mm² or at least 13 N/mm2.

The projections may be made of a material that is different from the material of the rest of the fastening member. In such a case the material of the first extension 112 has a first elastic modulus E₁, and the material of the projection has a second elastic modulus E₂. Preferably the ratio of elastic moduli, E₁/E₂, is at least 2, and even more preferably at least 3. This could ensure reasonable deformations for the projection, since the elastic modulus of the projection 152 would be smaller than the elastic modulus of the extension 112. However, as discussed, the fastening member may be made of one material only, whereby the ratio could be 1.

In case the fastening member 100 comprises two different materials, a layer of soft material may function as a projection 152. The thickness of the layer of the soft material may be e.g. at least 0.2 mm or 0.3 mm. The thickness of the layer of the soft material may be e.g. at most 1 mm or 2 mm. As a proportional value, the thickness of the layer of the soft material may be e.g. at least 5%, at least 10%, at least 20%, at least 30%, or at least 50% of the average thickness of the extension 152. The layer may arranged to the extension or extensions at least to the same side as the foot part. The layer may arranged to both sides of the extension.

In a fastening member, the height Hp of the projection 152 is at least 0.3 mm, preferably at least 1 mm. In an embodiment, the total height of the first extension 112 and the projection 152 is more than 5 mm. This ensures that the first extension 112 can be inserted into a groove having the height of at most 5 mm such that the projection 152 fixes the first extension 112 of the fastening member 100 into the groove. In an embodiment, The total height of the first extension 112 and the projection 152 is more than 6 mm, whereby the first extension can be inserted into a higher groove. Also, in an embodiment, the thickness of the first extension 112, without the projection 152, is less than 4 mm, preferably less than 3 mm. In this way, the first extension 112 can be inserted to a groove having the height of at least 3 mm. In addition, in some embodiments, the height Hp of the projection 152 (FIG. 2f) is at least 5%, at least 10%, at least 20%, or at least 30% of the average thickness of the extension 152.

An embodiment of the fastening member 100 is adapted to a groove having the height of about 6 mm. In this embodiment the total height of the first extension 112 and the projection 152 is more than 6 mm. In this embodiment the total height of the first extension 112 and the projection 152 is preferably less than 7.5 mm, less than 7 mm, or less than 6.5 mm. In addition, in the embodiment, the thickness of the first extension 112, without the projection 152, is less than 5.5 mm. However, to ensure sufficient strength, the thickness of the first extension 112, without the projection 152, is preferably at least 4 mm.

An embodiment of the fastening member 100 is adapted to a groove having the height of about 5 mm. In this embodiment the total height of the first extension 112 and the projection 152 is more than 5 mm. In this embodiment the total height of the first extension 112 and the projection 152 is preferably less than 6.5 mm, less than 6 mm, or less than 5.5 mm. In addition, in the embodiment, the thickness of the first extension 112, without the projection 152, is less than 4.5 mm. However, to ensure sufficient strength, the thickness of the first extension 112, without the projection 152, is preferably at least 3 mm.

An embodiment of the fastening member 100 is adapted to a groove having the height of about 4 mm. In this embodiment the total height of the first extension 112 and the projection 152 is more than 4 mm. In this embodiment the total height of the first extension 112 and the projection 152 is preferably less than 5.5 mm, less than 5 mm, or less than 4.5 mm. In addition, in the embodiment, the thickness of the first extension 112, without the projection 152, is less than 3.5 mm. However, to ensure sufficient strength, the thickness of the first extension 112, without the projection 152, is preferably at least 2 mm.

As for the measures of the foot part 120, the height Hf (FIG. 2b) of the foot part 120, as measured from the intersection of the foot part 120 and an extension (112, 114) to an end of the foot part 120, is at least 2 mm, preferably a least 3 mm. In relation to the average thickness of the first extension, in some embodiments, the height Hf of the foot part 120 is greater than half of the average thickness of the first extension Te, i.e. Hf>0.5×Te. This height has been sufficient to properly locate the fastening member 100 with the tongue 212 of an element 210 (cf. FIG. 2a).

Preferably, the height Hf (FIG. 2b) of the foot part 120 is reasonably small in comparison to the width We (cf. FIG. 1b) of the first extension 112. The width We of the first extension is defined as the measure from the central plane CP of the fastening member 100 to the exterior of first extension 112, in the second direction Sy. When the height Hf of the foot part is reasonably small, tilting (cf. FIG. 2d) will separate the elements 210, 220 from each other only a little. Tilting together with a high foot part 120 would press the elements 210, 220 away from each other. For these reasons, in a preferred embodiment, the ratio of the height Hf of the foot part 120 to the width We of the first extension, Hf/We, is at most 1.5. Preferably the ratio Hf/We is at most 1 and more preferably at most 0.7.

However, the height of the foot part may be reasonably large. This ensures that both the elements 210, 220 (FIG. 2a) can be aligned in respect to the foot part. Thus this ensures a proper spacing for the elements 210, 220. In an embodiment the height Hf of the foot part 120, as measured from the intersection of the foot part 120 and an extension 112 to an end of the foot part 120, is from 3 mm to 7 mm. In some of these embodiments, the height Hf of the foot part 120 is from 5 mm to 6.5 mm. The fastening member is often used in combination with an element having a tongue, wherein the tongue has the thickness Tt. Preferably the height Hf of the foot part 120 is less than twice the thickness Tt of the tongue, i.e. Hf<2×Tt. Preferably the height Hf of the foot part 120 is less than the thickness Tt of the tongue, i.e. Hf<Tt.

The foot part can be used to align the elements with respect to each other. The width Wf of the foot part 120 determines the spacing between two adjacent elements, as depicted in FIGS. 2a and 6b. Thus, the foot part 120 assures that the elements are easy to align with respect to each other that an even spacing is left between the elements. The width Wf of the foot part 120, as measured in the second direction Sy, is at least 3 mm, preferably at least 4 mm, and more preferably at least 5 mm. The width Wf of the foot part 120 is at most 12 mm, preferably at most 10 mm, and more preferably at most 8 mm. Specific examples for the width Wf include 5 mm, 6 mm, and 7 mm. Moreover, in and embodiment, the width Wf of the foot part 120 is greater than the diameter of the hole 140. These widths Wf ensure a proper spacing between the elements 210, 220. A reasonably large spacing between elements allows for circulation or air thereby increasing the service life. A reasonably small spacing between elements prevents a person from inserting fingers or toes to the space thereby increasing the safety of the arrangement.

To ensure a reasonable grip, the width We of the extension 112 (FIG. 1b) should be reasonably large compared to the width Wf of the foot part 120. By the definitions in FIGS. 1b and 2b, it is clear that Wf<2×We, wherein the limit corresponds to the case, where the width of the foot part equals to total width of the extensions 112 and 114. Preferably, however, the width Wf of the foot part is much smaller. Preferably Wf<1.5×We. In an embodiment, Wf<We. In an embodiment, Wf<(2/3)×We. As for absolute measures, preferably the width We of the extension exceeds half the width Wf of the foot part 120 by at least 5 mm, i.e. We>Wf/2+5 mm. However, preferably the extension is not too wide. Preferably the width We of the extension exceeds half the width Wf of the foot part 120 by at most 12 mm, i.e. We<Wf/2+12 mm.

In absolute measures, the width We of the extension may be e.g. at least 2 mm greater then Wf/2, or at least 4 mm greater than Wf/2. Moreover, the length Le of the extension (FIG. 1d) may be e.g. from 10 mm to 100 mm.

One function of the foot part 120 is to strengthen the hole 140. Therefore, in an embodiment, the width Wf of the foot part 120 is greater than the diameter of the hole 140. In an embodiment, the width Wf of the foot part 120 is greater than the diameter of the hole 140 by at least 1 mm, preferably at least 2 mm.

Moreover, the foot part 120 strengthens the whole fastening member 100. The foot part stiffens the first extensions 112, 114. However, for these strengthening purposes, the height Hf of the foot part 120 should be reasonably large. In an embodiment, the height Hf of the foot part is at least half of the average thickness of the first extension (Hf≧0.5×Te). In an embodiment, the height Hf of the foot part is at least the average thickness of the first extension (Hf≧Te).

Referring to FIG. 3a, the fastening member may comprise a second foot part 125. The second foot part 125 is connected to the at least one of the first extension 112 and the second extension 114, and extends from the at least one extension (112, 114) in the first direction Sx. The height of the second foot part 125, as measured from the intersection of the second foot part 125 and an extension (112, 114) to an end of the second foot part 125, is preferably at most 5 mm, and more preferably at most 2 mm. In this way, the second foot part 125 is not so clearly visible from the space between the elements 210, 220. Preferably the fastening member comprises only one foot part 120 (FIGS. 2).

FIGS. 4a to 4e show an embodiment of the fastening member 100. FIG. 4a shows the fastening member in a perspective view, while FIGS. 4b to 4e show the fastening member in various end views.

The fastening member of FIGS. 4a to 4e comprises, in addition to features previously disclosed, and shown with the same reference numerals in FIGS.

4a to 4b
a third extension 116 connected to the at least one of the first extension 112 and the second extension 114 and extending in a third direction Sz, wherein the third direction Sz is perpendicular to the first direction Sx and the third direction Sz is perpendicular to the second direction, and
a fourth extension 118 connected to the at least one of the first extension 112 and the second extension 114 and extending in a direction reverse to the third direction.

Also the third and/or the fourth extension may comprise a projection. An embodiment comprises a further projection 156 arranged to the third extension 116, and the further projection protrudes 156 to the first direction or to a direction reverse to the first direction.

Is discussed above, it is beneficial that the projections of all extensions extend at least to the direction reverse to the first direction (i.e. e.g. downwards). Such a fastening member 100 comprises
a first projection 152 arranged to the first extension 112 and extending to a direction −Sx that is reverse to the first direction,
a second projection 154 arranged to the second extension 114 and extending to a direction −Sx that is reverse to the first direction,
a third projection 156 arranged to the third extension 116 and extending to a direction −Sx that is reverse to the first direction, and
a fourth projection 118 arranged to the fourth extension 118 and extending to a direction −Sx that is reverse to the first direction.
   Preferably the fastening member further comprises a foot part 120 that extends also to the direction −Sx that is reverse to the first direction.

Referring specifically the FIG. 4b, the embodiment further comprises strengthening ribs 162, 164. As depicted in the FIGS. 4b and 4c, the thickness of the strengthening ribs in the first direction is less than the thickness of the projections 156, 158. Moreover, even if not explicitly shown in FIG. 4d, the thickness of a strengthening rib 162 in the first direction is less than the thickness of the projection 152 on the first extension 112. This applies also to the strengthening rib 164 and the projections 154 on the second extension 114. In a preferred embodiment, the first extension 112 comprises at least two projections 152. In a preferred embodiment, the second extension 114 comprises at least two projections 154. The thickness of a strengthening rib 162, 164 may be selected such that the total thickness of the extension (e.g. 112) and the strengthening rod of that extension (e.g. 152) is less than the height of the groove of the element. Therefore, the thickness of a strengthening rib 162 is less than the thickness of a projection 152. In some embodiments, the thickness of a strengthening rib 162 is less than the thickness of a projection 152 by at least 2 mm, or by at least 1 mm.

The strengthening rods have the technical effect that less material is needed for a sufficiently sturdy fastening member 100 and cooling time for the product is shorter. Therefore, material and production costs are reduced.

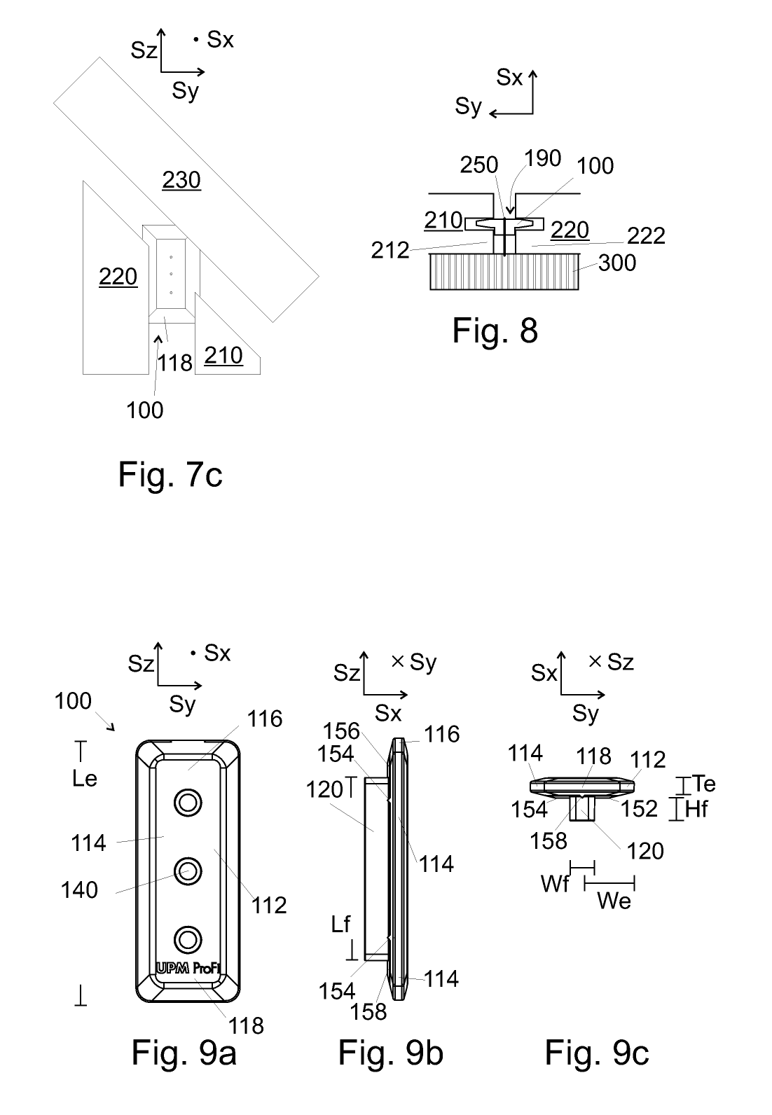

The fastening member 100 can be fixed to a support 300 using the hole 140 and a fixing means 250. When the fastening member is arranged in between two parallel elements 210, 220 (FIG. 6b), it suffices to fix the fastening member with only one fixing means. However, when the fastening member is arranged to fasten two elements that are perpendicular to each other (FIG. 7a), the fastening member is preferably fixed using two fixing means (e.g. screws). This is because in this case the elements easily impose some torque onto the fastening member. Therefore, an embodiment of the fastening member comprises two holes.

Preferably the same fastening member can be used to fasten parallel and perpendicular elements. In this case the fastening member comprises three holes, as shown in FIGS. 4a, 7a, and 7b. Preferably the fastening member comprises exactly three holes, i.e. does not comprise the fourth or a subsequent hole. Preferably one hole is located in the intersection of the central plane CP (FIG. 1b), and the second central plane CP2 (FIG. 1c) as defined above. Also preferably the other holes are located on the central plane CP or the second central plane CP2.

Thus, when fixing the fastening member as shown in FIGS. 6b and 6c, only the middle hole could be used for fixing. Moreover, when fixing the fastening member as shown in FIG. 7a, the other two holes could be used to fix the fastening member to the support. The hole or each of the holes is preferably arranged on a central plane (CP, CP2) of the fastening member. The central plane CP comprises the first direction Sx and has the surface normal in the second direction Sy. The second central plane CP2 comprises the first direction Sx and has the surface normal in the third direction Sz.

Thus, some embodiments of the fastening member comprise
at least a second hole 140 penetrating the fastening member 100 in a direction of the second hole, wherein the direction of the second hole (i) is parallel to the first direction or (ii) forms an angle of less than 45 degrees with the first direction, and
optionally, a third hole 140 penetrating the fastening member 100 in a direction of the third hole, wherein the direction of the third hole (i) is parallel to the first direction or (ii) forms an angle of less than 45 degrees with the first direction.

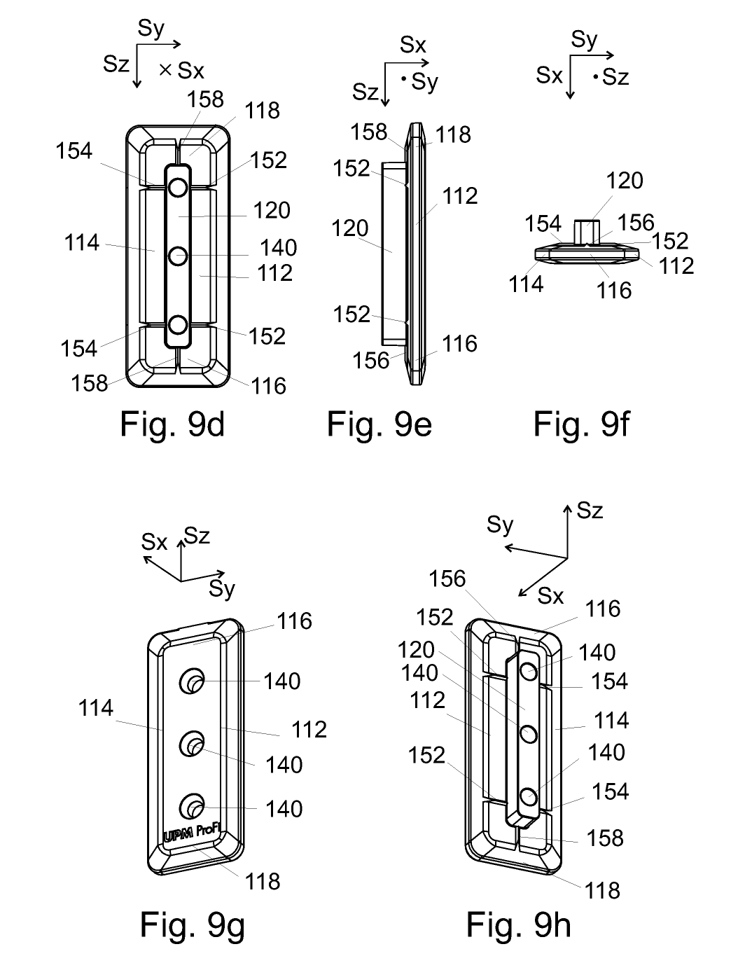

FIGS. 9a to 9h show in various views (as disclosed in the list of figures) a preferred embodiment of a fastening member 100. The fastening member comprises a first extension 112, a second extension 114, a third extension 116 and a fourth extension 118. Each extension comprises projection (152, 154, 156, 158). The fastening member further comprises a foot part 120. The foot part protrudes in the same direction as the projections of the extensions.

The measures of the preferred embodiment include:
the length Le of the first extension 112 (cf. FIG. 1d), being 63 mm,
the length Lf of the foot part 120 (in the third direction) being 44 mm,
the width We of the first extension 112 (cf. FIG. 1b), the width being equal to the width of the second extension 114, and being 12.5 mm,
the width Wf (FIG. 2b) of the foot part 120, being 6 mm,
the height Hf (FIG. 2b) of the foot part 120, being 6 mm,
the average thickness Te (FIG. 1b) of the first extension, being equal to the average thickness of the other extension, and being equal to 4.2 mm,
the width Wp of the projection 152 (FIG. 2f) being 1 mm at the intersection I (cf. FIG. 2f) and decreasing, as the projection protrudes, towards the end E.
the height Hp of the projection 152 (FIG. 2f) being 0.5 mm,

The material for the preferred embodiment was natural fibre reinforced polypropylene. The fastening member comprises the first 112, the second 114, the third 116, and the fourth 118 extensions. The number of projections in the first 112 and the second 114 extension is two. The number of projections in the third 116 and the fourth 118 extension is one. The fastening member comprises a foot part 120. The projections and the foot part 120 protrude in the same direction.

The fastening member 100 is preferably used in combination with an element 210, 220.

Referring to FIG. 5a, a combination comprises
the fastening member 100 of any of the previous examples,
at least a first element 210 comprising a groove 216 having a height Hg of the groove 216, wherein
the groove 216 is arranged in between a first tongue 212 and a second tongue 214, and wherein
the total thickness Tep of the first extension 112 and the projection 152 is greater than the height Hg of the groove, i.e. Hep>Hg. (It is noted that FIG. 5a shows, for clarity, this height for the second extension 114 and projection 154, which in FIG. 5a, however, are equal to the corresponding heights of the first extension 112 and the projection 152.)

The as the total thickness Tep is greater than the height Hg of the groove 216, the first extension 112, when inserted into the groove 216, will remain there even when the constructor releases his grip from the fastening member 100, as discussed above.

As discussed above, in a combination
the first extension can be inserted into the first groove using a force of at most 50 N or using an object having a momentum of at most 2 kgm/s.

Respectively, in an arrangement, wherein the first extension has been inserted into the groove, the fastening member is removable from the first groove with a force that is at most 50 N.

In an embodiment, the total thickness Tep (FIG. 5a) of the first extension 112 and the projection 152 is greater than the height Hg (FIG. 5a) of the groove 216 by at least 0.5 mm, i.e. Tep−H >0.5 mm. In some of these embodiments, the total thickness Tep is greater than the height Hg of the groove by at least 1 mm, i.e. Tep−Hg>1 mm. In some of these embodiments, the total thickness Tep is greater than the height Hg of the groove by at least 1 mm, i.e. Tep−Hg>2 mm.

Referring to FIG. 5b, the height Hg of the groove 216 may depend on the location, i.e. be a function Hg(z) of the location z in the third direction Sz. In a similar way, the thickness Tt of the tongue 212 may depend on the location, i.e. be a function Tt(z) of the location z in the third direction Sz. In a combination height Hg(z) and/or the thickness Tt(z) varies significantly as function of the location z.

The groove may have been made e.g. by extrusion or by machining. Machining is more common to solid objects such as planks, e.g. wooden planks. Some elements are made by extrusion, whereby a groove can be manufacture at the same time. However, even to extruded elements grooves can be machined. Typically machining produces more variation to groove height and location than extrusion. A fastening member 100 can be used with both extruded and machined grooves.

In an embodiment, the groove 216 comprises traces of removal of material by machining. Thus, the groove 216 has been manufactured to the element 210 by machining, i.e. by removing material. It is typically this machining that produces the variations to the height Hg of the groove 216 and/or to the thickness Tt of the tongue 212. FIG. 5b shows, in a side view, a groove 216 located in between two tongues 212, 214 of the element 210. As discussed above, the combination has several technical effects, particularly, when the height Hg of the groove 216 and/or the thickness Tt of the tongue 212 varies. FIG. 5b shows these issues slightly exaggerated.

As for the height of the height Hg of the groove 216, in a combination
in a first location z1, the groove 216 has a first height Hg(z1), and
in a second location z2, the groove 216 has a second height Hg(z2), wherein the locations z1, z2 may be arranged such that second height Hg(z2) is less than the first height Hg(z1), and
the ratio of the first height Hg(z1) to the second height Hg(z2), Hg(z1)/Hg(z2), is at least 1.01.
   The ratio may be also more, e.g. at least 1.02, at least 1.05, or at least 1.1.

As for the thickness Tt of the tongue 212, in a combination
in a first location z1, the first tongue 212 has a first thickness Tt(z1) , and
in a second location z2, the first tongue 212 has a second thickness Tt(z2), wherein the locations z1, z2 may be arranged such that second the second thickness Tt(z2) is less than the first thickness Tt(z1), and
the ratio of the first thickness Tt(z1) to the second thickness Tt(z2), Tt(z1)/Tt(z2), is at least 1.01.
   The ratio may be also more, e.g. at least 1.02, at least 1.05, or at least 1.1.

Referring to FIGS. 2d and 2e, the variations in the thickness of the tongue may occur also from one element 210 to another element 220. FIG. 5c shows another element 220 in a side view. A combination may thus further comprise a second element 220. The second element comprises a second groove 226, arranged in between a third tongue 222 and a fourth tongue 224. In the combination
in a first location z1, the first tongue 212 has a first thickness Tt(z1), and
in the first location z1 or a second location z2, the third tongue 222 has a third thickness Tt2(z2), wherein the elements (210, 220) and/or the locations (z1, z2) are ordered such that the third thickness Tt2(z2) is less than the first thickness Tt(z1), and the second location z2 may be the first location z1, i.e. z2 may equal z1,
the ratio of the first thickness Tt(z1) to the third thickness Tt2(z2), Tt(z1)/Tt(z2), is at least 1.01.
   The ratio may also be at least 1.02, at least 1.05, or at least 1.10.

In some embodiments, the thickness of the tongue is from 5 mm to 12 mm. In some embodiments, the thickness of the tongue is from 9 mm to 11 mm. In some embodiments, the manufacturing tolerance for the thickness of the tongue is such that the thickness is from 9 mm to 11 mm, and both values are achieved in a process—either in a single element, or in a set comprising multiple elements. Thus in a set of elements, the ratio of thicknesses, Tt(z1)/Tt(z2), may be as high as 1.2. Assuming that both the minimum and maximum values are present an a combination comprising one or two elements, at one or two locations, the ratio between the values is about 1.22, i.e. more than 1.15, or more than 1.2.

Preferably, the element (210, 220) comprises natural fibers. The element 210 may e.g. consist of wood, or the element 210 may comprise natural fibers in a polymer matrix. The element may comprise material that comprises natural fibres. The element may comprise e.g. sawdust admixed with a polymer matrix. The polymer may comprise polyolefin, such as polypropylene or polyethylene.

In the combination, the height of the foot part may be selected such that the height of the foot part is arranged not to contact a support, when the fastening member 100 is used in connection with the element 210, 220. In such a combination,
in a first element 210 the first tongue 212 has a thickness Tt, and
the fastening member 100 comprises a foot part 120 connected to the at least one of the first extension 112 and the second extension 112, and extending from the at least one extension (112, 114) in a direction −Sx that is reverse to the first direction Sx, and
the height Hf of the foot part 120 of the fastening member 100 is less than the thickness Tt of the first tongue.

In a combination, the height Hf of the foot part 120 may be less than the thickness Tt of the tongue 212 by at least 1 mm. In a combination, the height Hf of the foot part 120 may be less than the thickness Tt of the tongue 212 by at least 2 mm. In a combination, the height Hf of the foot part 120 may be less than the thickness Tt of the tongue 212 by at least 3 mm.

As discussed, the thickness of the tongue, Tt, may vary. In a combination, the height Hf of the foot part 120 may be less than the minimum thickness of the tongue 212, min(Tt(z)), cf. FIG. 5b. In a combination, the height Hf of the foot part 120 may be less than the minimum thickness of the tongue 212 by at least 1 mm, i.e. min(Tt(z))−Hf 1 mm; or by at least 2 mm.

In a corresponding arrangement, such a combination leaves a spacing in between the fastening member 100 and the support 300. This ensures air circulation and helps to keep the structure dry.

In a preferred embodiment, the groove 216 is arranged in between the first tongue 212 and a second tongue 214. However, in general only one tongue suffices (FIG. 1a, element 220). An embodiment of a combination comprises
a fastening member 100 as discussed above, the fastening member 100 comprising a foot part 120 connected to the at least one of the first extension 112 and the second extension 114, and wherein the foot 120 part extends from the at least one extension in a direction that is reverse to the first direction; and
at least a first element 210 comprising a first tongue 212, wherein
the height Hf of the foot part 120 of the fastening member 100 is less than the thickness Tt of the first tongue 212.
   The difference between the height of the foot and the thickness of the tongue was discussed above.

A fastening member can be arranged in to an arrangement, as depicted e.g. in FIGS. 6b and 6c. Such an arrangement comprises
a fastening member 100 as described above,
a first element 210 comprising a first groove 216,
a second element 220 comprising a second groove 226, wherein
the second element 220 is arranged parallel or substantially parallel to the first element 210,
the first extension 112 of the fastening member 100 is arranged to the first groove 216, and
the second extension 114 of the fastening member 100 is arranged to the second groove 226.

The second element 220 may be arranged parallel to the first element 210, as depicted in FIG. 6c. Generally the element 210 has a shape of a rectangular parallelepiped with three dimensions. The greatest of these dimensions may be referred to as length. The elements are parallel when their lengths are parallel. The elements are substantially parallel when their lengths are substantially parallel. The lengths are substantially parallel when the angle between the direction of the length of the first element and the direction of the length of the second element is less than 0.5 degrees. The term “angle” here refers to the smaller of the two angles defined by two directions in a plane comprising both the directions.

The fastening member shown in FIG. 4a can be used to fasten two elements that are arranged in an angle relative to each other. It can also be used to attach three elements, of which two are parallel and one is arranged in an angle, e.g. one is perpendicular to the others. These issues are illustrated in FIGS. 7a-7c. FIG. 7a shows an arrangement, wherein
the fastening member 100 comprises a third extension 116 connected to at least one of the first extension 112 and the second extension 114 and extending in a third direction Sz, wherein the third direction Sz is perpendicular to the first direction Sx, and the third direction Sz is perpendicular to the second direction Sy; and the arrangement comprises
a further element 230 comprising a further groove 236 (compare to FIGS. 6b and 6c),
the further element 230 is arranged in an angle relative to the first element 210, wherein the angle is at least 25 degrees,
the first extension 112 of the fastening member 100 is arranged to the groove 216 of the first element 210, and
the third extension 116 of the fastening member 100 is arranged to the groove 236 of the further element.

Referring to FIG. 7b, the elements may be arranged perpendicularly or essentially perpendicularly. The elements are perpendicular when their lengths are perpendicular to each other. The elements are substantially perpendicular when their lengths are substantially perpendicular to each other. The lengths are substantially perpendicular to each other, when the angle between the direction of the length of the first element and the direction of the length of the second element is more than 89.5 degrees. The term “angle” here refers to the smaller of the two angles defined by two directions in a plane comprising both the directions.

However, referring to FIG. 7c, the elements may be arranged in another angle with respect to each other. In FIG. 7c, the third element 230 is arranged in an angle of 45 degrees relative to the first element 210. Typical angles of at least 25 degrees in this context include 30±2 degrees, 45±2 degrees, and 60±2 degrees.

The “further element 230” may be a second element, as shown in FIG. 7a. However, in a more common case, the “further element 230” is a third element, and the fastening member 100 is used to fasten three elements. This is depicted in FIGS. 7b and 7c.

A fastening member of an arrangement may comprise the fourth extension 118, as discussed above.

In an arrangement, the fastening member is located a distance apart from the support, as depicted e.g. in FIG. 2a. This is achieved by selecting, in a corresponding combination of the fastening member 100 and an element 210, the height Hf of the foot part 120 such that the height Hf of the foot part 120 is less than the thickness Tt of the tongue 212, as discussed above.

Even if the projection 152 enables the fastening member 100 to be easily fixed to a groove 216, the problem related to tilting of the fastening member is solved even if the element 210, 220 comprises only one tongue. Such an arrangement comprises
a fastening member 100 as disclosed above,
a first element 210 comprising at least a first tongue 212 of the first element 210,
a second element 220 comprising at least a first tongue 222 of the second element 220,
a support 300, and
a fixing means 250, wherein
the first tongue 212 of the first element 210 is arranged in between the first extension 112 of the fastening means 100 and the support 300,
the projection 152 of the fastening means 100 protrudes towards the support 300, and
the first tongue 222 of the second element 220 is arranged in between the second extension 114 of the fastening means 100 and the support 300.

Also in this case, a foot part 120 can be used to control the spacing between the elements. Thus, in an embodiment,
the fastening member 100 further comprises a foot part 120 connected to at least one of the first extension 112 and the second extension 114, and in the arrangement
the foot part 120 extends from the at least one extension 112, 114 in a direction −Sx that is reverse to the first direction Sx, and
the projection 152 protrudes in the direction −Sx that is reverse to the first direction Sx.

Issues discussed above for the thickness variation for the element, and optionally to a second element, apply. Moreover, issues related to the relation between the height Hf of the foot part 120 and the thickness Tt of the tongue 212 are valid also in the case, wherein the element 210, 220 comprises only one tongue on a side, i.e. a groove is not arranged in between two tongues.

When fastening elements (210, 220, 230) to a support 300 and to each other, a method for fastening two elements (210, 220, 230) to a support 300 is performed. In the method, a first element 210 may already be arranged next to a support 300. In the alternative, also the first element may be arranged available and arranged next to the support 300. The elements 210, 220 may be elements for flooring, whereby they are arranged on to a support. However, the elements 210, 220 may be elements for ceiling, whereby they are arranged under a support. In these cases and also in walls, the elements 210, 220 are arranged next to a support 300.

The method comprises
optionally, arranging available a first element 210 comprising a first groove 216 and arranging the first element 210 next to a support 300,
arranging available a fastening member 100 as described above,
arranging available a second element 220 comprising a second groove 226, and in the following order either
(a,i) inserting the first extension 112 of the fastening member 100 to the first groove 216 of the first element 210,
(a, ii) arranging the second element 220 such that another extension (i.e. the second extension 114, the third extension 116, or the third extension 118) of the fastening member 100 becomes arranged into the second groove 226, and
(a, iii) fixing the fastening member 100 to the support 300 using a fixing means 250 such as a screw; OR
(b,i) inserting the first extension 112 of the fastening member 100 to the second groove 226 of the second element 220,
(b, ii) arranging the second element 220 such that another extension (i.e. the second extension 114, the third extension 116, or the third extension 118) of the fastening member 100 becomes arranged into the first groove 216, and
(b, iii) fixing the fastening member 100 to the support 300 using a fixing means 250 such as a screw.

The alternatives are herein defined, since in an embodiment, only the second element 220 is arranged available, while the first element 210 is already fixed from another groove.

The “another extension” refers to the second extension 114, when the elements are aligned parallel to each other (FIG. 6b). The “another extension” refers to the third extension 116, when the elements are aligned perpendicular to each other (FIG. 7a).

In particular, the method comprises either
(a,i) inserting the first extension 112 of the fastening member 100 to the first groove 216 of the first element 210, and without prefixing the fastening member 100 to the support,
(a, ii) arranging the second element 220 such that another extension (i.e. the second extension 114, the third extension 116, or the third extension 118) of the fastening member 100 becomes arranged into the second groove 226; OR
(b,i) inserting the first extension 112 of the fastening member 100 to the second groove 226 of the second element 220, and without prefixing the fastening member 100 to the support,
(b, ii) arranging the second element 220 such that another extension (i.e. the second extension 114, the third extension 116, or the third extension 118) of the fastening member 100 becomes arranged into the first groove 216, and

The described order is possible because of the structure of the fastening member. If a fastening means without the projection would be used, the fastening means should be fixed or pre-fixed to the support 300 already after the first extension had been inserted to the first groove. If not pre-fixed, such a fastening means would fall off from the element. However, in the present case, the projection 152 fixes the first extension 112 to the first groove 216, whereby the pre-fixing can be omitted. This saves time on the construction site. Additional benefits related to the size variations of the elements were discussed above.

Moreover, in practice it may be easier to arrange the extension 112 of the fastening member 100 to the first element that has already been arranged next to a support. Thus, of the choices (a) and (b), the option (a), i.e. (a,i), (a,ii) and (a,iii) may be preferable.

As described above, inserting the first extension 112 to the first groove 216 preferably requires only a relatively small force or a relatively low impact. An embodiment of the method comprises
inserting the first extension of the fastening member to the first groove of the first element, using a force of at most 50 N, or an object having a momentum of at most 1 kgm/s.

In a similar way, the first extension 112 may be inserted to the second groove 226 of the second element with a relatively small force or a relatively low impact.

Once inserted, the fastening member 100 is preferably also removable from the first groove 216. E.g. a user may accidentally insert the fastening member to a wrong location, whereby it should be removable. Preferably the fastening member 100 is removable from the groove 216 with a force that is at most 50 N, more preferably at most 30 N.

It has also been found that, regardless of some details of the fastening member, a gap in between a support and a fastening member helps air circulation, and thereby increases the service life of the arrangement. For this air circulation, the projection is not necessary. Referring to FIG. 8, a corresponding combination comprises
a fastening member 190 (a different reference number, since this fastening member 190 lacks the projection 152), comprising
   a first extension 112 having a height Te in a first direction Sx and extending in a second direction Sy, wherein the second direction Sy is perpendicular to the first direction Sx,
   a second extension 114 connected to the first extension 112 and extending in a direction −Sy that is reverse to the second direction Sy,
   at least one hole 140 penetrating the fastening member in a direction such that the central axis of the hole is parallel to the first direction Sx or forms a first angle with the first direction Sx, wherein the first angle is less than 45 degrees, and
   a foot part 120 connected to the at least one of the first extension 112 and the second extension 114, and extending from the at least one extension 112 in a direction reverse to the first direction, and
an element 210 comprising a first tongue 212, and
the first tongue 212 has a first tongue thickness Tt, wherein the height of the foot part of the fastening member is less than the thickness of the first tongue.

In a combination, the groove is arranged in between two tongues.

The combination may be used in an arrangement. The arrangement further comprises a second element 220 comprising a first tongue 222 of the second element, and a support 300. In the arrangement the second element 220 is arranged parallel to the first element 210; the first tongue 212 of the first element 210 is arranged in between the first extension 112 of the fastening member 190 and the support 300; and the first tongue 222 of the second element 220 is arranged in between the second extension 114 of the fastening member 190 and the support 300, whereby the fastening member 190 is located a distance apart from the support 300.

An arrangement comprises a fixing means 250, and in the arrangement, the fixing means 250 penetrates through the hole 140 of the fastening means 190 to the support 300, and the fastening member 190 is located a distance apart from the support 300.

1. A fastening member, comprising
a first extension (i) having a thickness in a first direction, (ii) extending in a second direction, wherein the second direction is perpendicular to the first direction, and (iii) having a length in a third direction, wherein the third direction is perpendicular to the first direction and the third direction is perpendicular to the second direction,
a second extension connected to the first extension and extending in a direction that is reverse to the second direction,
a foot part connected to the at least one of the first extension and the second extension, wherein
the foot part extends from the at least one extension in a direction that is reverse to the first direction and
a width of the foot part in the second direction is configured to determine the spacing between two adjacent elements to be fastened by the fastening member, the fastening member comprising
at least one hole penetrating the fastening member such that the central axis of the hole is parallel to the first direction or forms a first angle with the first direction, wherein the first angle is less than 45 degrees, and
at least one projection, wherein
the projection protrudes from the first extension to the first direction or to a direction that is reverse to the first direction,
the projection extends in a direction of extension, and
the direction of extension is parallel to the second direction or forms a second angle with the second direction, wherein the second angle is at most 45 degrees,
characterized in that
the first extension has a first thickness at a first location,
the first extension has a second thickness at a second location, wherein
the second thickness is less than the first thickness, and
the second location is closer to a boundary of the first extension than the first location.

2-5. (canceled)

6. The fastening member of claim 1, wherein
the shape of the fastening member defines a central plane having a surface normal parallel to the second direction and dividing the fastening member to two equally large parts,
the first extension has a width from the central plane of the fastening member to the boundary of the first extension in the second direction, and
the thickness of the first extension depends on the point of observation in such a way that
the thickness of the first extension starts to decrease a distance apart from the central plane, wherein
the distance is at most 75%, preferably at most 66% of the width of the first extension.

7. The fastening member of claim 1, wherein
the shape of the fastening member defines a central plane having a surface normal parallel to the second direction and dividing the fastening member to two equally large parts,
the first extension has first thickness at the central plane, or if a foot part is present, at the point where the first extension intersects with a foot part,
the first extension has second thickness at the boundary of first extension, wherein the boundary is located towards the second direction from the central plane,
the ratio of the second thickness to the first thickness is at most 90%, preferably at most 75%.

8. The fastening member of claim 1, wherein
the shape of the fastening member defines a central plane having a surface normal parallel to the second direction and dividing the fastening member to two equally large parts,
the first extension has first thickness at the central plane, or if a foot part is present, at the point where the first extension intersects with a foot part,
the first extension has second thickness at the boundary of first extension, wherein the boundary is located towards the second direction from the central plane,
the second thickness is less than 3.5 mm and
the first thickness is from 4.0 mm to 4.8 mm.

9-10. (canceled)

11. The fastening member of claim 1, wherein
the projection has width in a direction that is perpendicular to the first direction,
the projection has a first width at an intersection between the first extension and the projection,
the projection has a second width at the other end of the projection, wherein the other end of the projection is located in the first direction or a direction that is reverse to the first direction, from the intersection, and
the second width is smaller than the first width.

12. (canceled)

13. The fastening member of claim 1, wherein
the projection protrudes in a direction that is reverse to the first direction.

14-16. (canceled)

17. The fastening member of any of claim 1, wherein
the total cross sectional area of the projections protruding from the first extension as observed from the first direction is Aptot,
the cross sectional area of the first extension as observed from the first direction is Ae1, and
the ratio Aptot/Ae1 is at most 25%; preferably at most 10%, or at most 5%.

18. (canceled)

19. The fastening member of claim 1, comprising
a second projection, wherein
the second projection is arranged to the second extension,
the second projection protrudes to the first direction or to a direction reverse to the first direction.

20-23. (canceled)

24. The fastening member of claim 1, wherein
the height of the foot part, as measured from the intersection of the foot part and an extension to an end of the foot part, is at least 2 mm, preferably
from 3 mm to 7 mm

25. (canceled)

26. The fastening member of claim 1, wherein
the first extension has a width from the central plane of the fastening member to the exterior of the first extension in the second direction,
the foot part has a width, and
the width of the first extension exceeds half the width of the foot part by at least 5 mm, and by at most 12 mm.

27. (canceled)

28. The fastening member of claim 1, wherein
the width of the foot part, as measured in the second direction, is at least 3 mm, preferably
at most 15 mm.

29-32. (canceled)

33. The fastening member of claim 1, comprising
a third extension connected to at least one of the first extension and the second extension and extending in a third direction, wherein the third direction is perpendicular to the first direction, and the third direction is perpendicular to the second direction.

34. The fastening member of claim 33, comprising
a fourth extension connected to at least one of the first extension and the second extension and extending reverse to the third direction.

35. The fastening member of claim 33, comprising
a further projection arranged to the third extension, wherein
the further projection protrudes to the first direction or to a direction that is reverse to the first direction.

36. The fastening member claim 1, comprising
a first projection that is arranged to the first extension and protrudes to a direction that is reverse to the first direction,
a second projection that is arranged to the second extension and protrudes to a direction that is reverse to the first direction,
a third extension connected to at least one of the first extension and the second extension and extending in a third direction, wherein the third direction is perpendicular to the first direction, and the third direction is perpendicular to the second direction,
a third projection that is arranged to the third extension and protrudes to a direction that is reverse to the first direction,
a fourth extension connected to at least one of the first extension and the second extension and extending reverse to the third direction, and
a fourth projection that is arranged to the fourth extension and protrudes to a direction that is reverse to the first direction.

37-64. (canceled)

65. A method for fastening two elements to a support, the method comprising
optionally arranging available a first element comprising a first groove and arranging the first element next to a support,
arranging available a fastening member of claim 1,
arranging available a second element comprising a second groove,
and the method comprises, in the following order
(a,i) inserting the first extension of the fastening member to the first groove of the first element,
(a, ii) arranging the second element such that another extension of the fastening member becomes arranged into the second groove, and
(a, iii) fixing the fastening member to the support using a fixing means such as a screw; OR in the following order
(b,i) inserting the first extension of the fastening member to the second groove of the second element,
(b, ii) arranging the second element such that another extension of the fastening member becomes arranged into the first groove, and
(b, iii) fixing the fastening member to the support using a fixing means such as a screw.

66. The method of claim 65 comprising, in the following order
(a,i) inserting the first extension of the fastening member to the first groove of the first element,
(a, ii) arranging the second element such that another extension of the fastening member becomes arranged into the second groove, and
(a, iii) fixing the fastening member to the support using a fixing means such as a screw.

67. The method of claim 65, comprising
arranging the second element such that the second extension of the fastening member becomes arranged into the second groove and the first extension becomes arranged in the first groove, or
arranging the second element such that the first extension of the fastening member becomes arranged into the second groove and the second extension becomes arranged in the first groove.

68. (canceled)

69. The method of claim 65, comprising
inserting the first extension of the fastening member to the first groove of the first element or to the second groove of the second element, using a force of at most 50 N, or an object having a momentum of at most 2 kgm/s.

70-73. (canceled)

74. The fastening member of claim 1, comprising
thermoplastic polymer.
